(19) United States
(12) Patent Application Publication
(10) Pub. No.: US 2010/0294479 A1
(43) Pub. Date: Nov. 25, 2010

(54) WINCH ASSEMBLY

(76) Inventor: Graham Shee, Aberdeenshire (GB)

Correspondence Address: TAROLLI, SUNDHEIM, COVELL & TUMMINO L.L.P., 1300 EAST NINTH STREET, SUITE 1700, CLEVELAND, OH, 44114, US

(21) Appl. No.: 12/670,653

(22) PCT Filed: Jul. 28, 2008
(86) PCT No.: PCT/GB08/02559

§ 371 Date: Jun. 21, 2010

(30) Foreign Application Priority Data
Jul. 31, 2007 (GB) 0714880.2

(51) Int. Cl. E21B 23/14; E21B 19/08; B66D 1/00; B66D 1/39; G01M 19/00

(52) U.S. Cl. 166/65.1; 166/77.1; 254/266; 73/865.8

(57) ABSTRACT

A winch assembly (30) comprises a winch chamber (32) defined within a housing (31) which includes an orifice to permit fluid communication with a wellbore. A winch drum (34) which supports a spoolable medium (36), such as wireline, is rotatably mounted within the winch chamber (32). A cavity (50) containing a fluid, such as lubrication oil, is defined within the housing (31) and a sealing arrangement is provided between the winch chamber (32) and the cavity (50). The winch assembly (30) also includes a pressure compensator (62) adapted to maintain the cavity (50) at least at the same pressure as the winch chamber (32).

### FIELD OF THE INVENTION

The present invention relates to a winch assembly, and in particular to a winch assembly for deploying a spoolable medium into and from a wellbore.

### BACKGROUND TO THE INVENTION

Winch assemblies are widely utilised in the oil and gas industry, for example for deploying objects, such as tools or the like into wellbores on a spoolable medium. The spoolable medium may include wireline, coiled tubing or the like. However, for convenience, the present description refers to wireline. In conventional well operations, winches are located at surface level, such as on a platform, and the wireline extends into a wellbore through special surface equipment such as Blow Out Preventors (BOPs), injectors, stuffing boxes and the like which maintain a seal between the wellbore and the environment.

Surface mounted winches are based on a common basic design and include a rotatable drum for supporting the wireline, a drive source, such as a motor, for rotating the drum, and a transmission assembly, such as a gear box for transmitting drive to the drum. As the winch is mounted within ambient conditions, conventional components and equipment may be readily utilised. For example, conventional methods of lubricating the various components of surface mounted winches, such as gear boxes, bearings and the like may be used, along with conventional methods of sealing lubricant within the winch.

Furthermore, a winch operator normally has the benefit of being able to view the winch during use, and as such can determine the quantity of wireline present on the winch drum and the like. Also, access to the winch drum for maintenance and the like is relatively straightforward.

However, recent developments in the oil and gas industry has called for winch assemblies that can be utilised subsea. For example, the present applicant has proposed a subsea wireline intervention system which is completely self-contained, including all of the equipment required for running intervention operations. This subsea intervention system, which is disclosed in WO 2004/065757, is mounted on a Christmas tree and includes a tool storage chamber and a wireline winch assembly, both of which are exposed to wellbore fluids and pressure. In use, a required tool is selected from the storage chamber and is coupled to the wireline. The tool may then be run downhole. Once the downhole operation is completed the tool may be retrieved to the storage chamber and uncoupled from the wireline.

It would be understood by those of skill in the art that conventional surface mounted winches are unsuitable for subsea use, and also unsuitable for use within a wellbore fluid environment, without requiring significant modifications.

### SUMMARY OF THE INVENTION

According to a first aspect of the present invention there is provided a winch assembly comprising:

a housing;

a winch chamber defined within the housing and defining an orifice adapted to permit fluid communication with a wellbore;

a winch drum rotatably mounted within the winch chamber and supporting a spoolable medium;

a cavity defined within the housing and containing a fluid;

a sealing arrangement defined between the winch chamber and the cavity; and

a pressure compensator adapted to maintain the cavity at least at the same pressure as the winch chamber.

Accordingly, the present invention, in use, permits the fluid within the cavity to be maintained at substantially the same pressure as the well bore fluid within the winch chamber, without exposing the cavity to wellbore fluids, thus minimising the pressure differential across the sealing arrangement and therefore the risk of leakage.

The cavity may contain a lubricant, such as mineral oil or the like, for lubricating components of the winch assembly disposed within the cavity, for example.

In embodiments of the invention the sealing arrangement may comprise a static seal disposed between fixed components of the winch assembly. Alternatively, or additionally, the sealing arrangement may comprise a dynamic seal, such as a shaft seal. It is understood that the sealing integrity of a dynamic seal is difficult to maintain with high pressure differentials. Accordingly, the present invention presents particular advantages when a dynamic sealing arrangement is disposed between the winch chamber and the cavity.

The winch assembly may be adapted for use in a subsea location, for example mounted on top of a subsea wellhead, Christmas tree or the like. Alternatively, or additionally, the winch assembly may be adapted to be operated at a topside location, for example on a platform or the like.

The pressure compensator may comprise a moveable member disposed between the winch chamber and the cavity. One side of the moveable member may be in fluid communication with wellbore fluid within the winch chamber, either directly or indirectly. An opposite side of the moveable member may be in fluid communication with the fluid within the cavity, either directly or indirectly. In use, fluid pressure acting on one side of the moveable member will be applied to the fluid on the other side of the moveable member.

The moveable member may comprise a piston body. The piston body may be mounted within a cylinder and divide the cylinder into two cylinder chambers, wherein a first cylinder chamber is in fluid communication with the winch chamber and the second chamber is in fluid communication within the cavity.

The moveable member may comprise a diaphragm structure. The diaphragm structure may comprise a flexible structure, which may comprise a plastic material, elastic material or the like, or any suitable combination of materials.

The pressure compensator may comprise forcing means adapted to apply a positive pressure into one of the winch assembly and cavity. In this arrangement the fluid pressure in one of the winch chamber and cavity may be maintained at a greater pressure than the fluid within the other of the winch chamber and cavity. Accordingly, maintaining a slight pressure differential in a controlled direction permits control over any leakage which may occur across the sealing arrangement.

In one embodiment the positive pressure is applied into the cavity such that any leakage across the sealing arrangement will be from the cavity and into the winch chamber. This is advantageous in that wellbore fluids will not be permitted to leak from the winch chamber and into the cavity.

The forcing means may comprise a spring, which in embodiments may apply a force against the moveable member of the pressure compensator. The spring may comprise a coil spring, elastic body or the like.

The cavity may comprise a drive assembly, transmission assembly, bearing assembly, electrical connector, or the like, or any combination thereof.

In one embodiment the cavity may comprise a first cavity defined within the housing. A divider plate may be mounted within the housing to separate the winch chamber from the first cavity. An outer peripheral edge of the divider plate may engage an inner peripheral surface of the housing, wherein the sealing arrangement may be disposed between said outer and inner surfaces. Alternatively, the divider plate may be clamped between parts of the housing, and a seal, such as a gasket seal, may be provided between the parts of the housing and the divider plate.

A portion of the winch drum, preferably a rotatable portion, may extend through the divider plate and into the first cavity. The sealing arrangement may comprise a dynamic seal between the divider plate and the rotatable portion of the winch drum to provide sealing between the winch chamber and the first cavity.

The winch assembly may further comprise a drive assembly at least partially contained within the first cavity and adapted to be coupled to the winch drum to cause said winch drum to rotate. The drive assembly may be entirely located within the first cavity. Alternatively, at least a portion of the drive assembly may be located externally of the first cavity or of the housing.

The drive assembly may comprise a drive source incorporating a drive shaft coupled to the winch drum. The drive source may comprise a motor, such as an electric motor. The motor may be mounted within a motor housing.

In one embodiment the drive source may be mounted within the cavity. In other embodiments the drive source may be mounted externally of the cavity, and may be coupled to the housing, for example via a bolting arrangement or the like. In this arrangement the drive shaft may extend into the first cavity through a wall portion of the housing to engage the winch drum, either directly or indirectly. A dynamic seal may be provided between the drive shaft and the housing to prevent leakage of fluids, such as lubricant, from the first cavity past the drive shaft. The dynamic seal may be adapted to prevent leakage between the cavity and the drive source or alternatively, or additionally between the cavity and the ambient environment within which the winch assembly is located.

It is preferred that the dynamic seal be capable of accommodating a pressure differential between the fluid pressure within the cavity and the pressure within the drive source, and/or ambient pressure. This advantageously will prevent or minimise fluid leakage between the drive source and the cavity. In embodiments of the invention a pressure compensator may be provided between the cavity and the drive source.

The drive assembly may further comprise a shaft casing coupled to an internal surface of the cavity, wherein the drive shaft is adapted to extend through the wall of the housing and into the shaft casing. A dynamic seal may be provided between the drive shaft and the wall of the housing, such that the shaft casing may be sealed from the drive source.

Alternatively, in a preferred embodiment the shaft casing may be in fluid communication with the drive source through the wall of the housing, such that the requirement for a dynamic seal is eliminated. Also, in a preferred embodiment a pressure compensator may be provided between the drive source and the ambient environment. In this arrangement the fluid pressure within the drive source and the shaft casing may be maintained substantially balanced with the ambient pressure.

A static seal may be provided between the shaft casing and the internal surface of the cavity. Accordingly, the shaft casing may be sealed from the fluid within the cavity. In this arrangement, a relatively large pressure differential may be established between the cavity and the shaft casing and optionally the drive source or external environment in that sealing integrity may be maintained by a more efficient static seal rather than a dynamic seal.

In the arrangement incorporating a shaft casing, the shaft may be indirectly coupled to the winch drum via a non-contact coupling arrangement such as a magnetic coupling or the like.

The drive assembly may further comprise a transmission assembly positioned between the drive shaft and the winch assembly. The transmission assembly may comprise a gear train, chain drive, belt drive or the like. The drive shaft may be directly coupled to the transmission assembly, or alternatively may be indirectly coupled to the transmission assembly, for example via a non-contact coupling.

The drive assembly may further comprise secondary drive means. The secondary drive means may comprise a shaft interface adapted to permit an external drive source to be drivingly coupled to the drive shaft of the drive assembly. The shaft interface may be located externally of the casing. The shaft interface may be adapted to be engaged by a Remotely Operated Vehicle (ROV) or the like.

In a preferred embodiment the drive assembly comprises a shaft casing adapted to extend across the first cavity between internal wall surfaces of said cavity, wherein the shaft casing is sealingly secured to the internal wall surfaces of the first cavity. The drive shaft may extend through the shaft casing between the drive source and the secondary drive means.

The winch assembly may further comprise a winch drum support shaft adapted to support the winch drum and permit rotation thereof within the winch chamber. In one embodiment the winch drum support shaft may be rotatably mounted within the housing, for example via suitable bearings, and the winch drum may be fixed relative to the shaft so as to be rotatable therewith. In this arrangement the shaft may extend through the divider plate and into the first cavity to be drivingly engaged by the drive assembly.

In an alternative embodiment the winch drum support shaft may be fixed relative to the housing and the winch drum may be rotatably mounted on the shaft via suitable winch drum bearings. The winch drum may comprise a tubular support member adapted to be rotatably mounted about the support shaft. The tubular support member may extend through the divider plate and into the first cavity to be drivingly engaged by the drive assembly.

The cavity may comprise a second cavity defined between the winch drum support shaft and the winch drum tubular support member, wherein the second cavity contains winch drum bearings. The second cavity may contain a lubricant fluid adapted to lubricate the winch drum bearings. In a preferred embodiment the second cavity is in fluid communication with the first cavity. In this arrangement the second cavity may also be pressure compensated with the winch drum chamber.

Alternatively, the second cavity may be fluidly isolated from the first cavity. In this arrangement the second fluid cavity may comprise a separate pressure compensator provided between the second cavity and the winch chamber, or the first cavity.

The cavity may further comprise a third cavity defined within the housing. A further divider plate may be provided within the housing to separate the winch chamber from the third cavity. The further divider plate may be similar to the divider plate positioned between the winch chamber and the first cavity. The further divider plate may sealingly separate the winch chamber from the third cavity. Alternatively, the further divider plate may permit fluid communication between the winch chamber and the cavity.

The third cavity may be in fluid communication with the second cavity. This arrangement may eliminate the requirement for a dynamic seal to be provided between the winch drum support shaft and the winch drum tubular support member in that fluid isolation from the winch chamber may be provided by the further divider plate. Alternatively, the third chamber may be isolated from the second fluid cavity.

The winch drum support shaft may be tubular and define a through bore adapted to provide a passage extending through the housing. The passage may be adapted to be in fluid communication with a wellbore. Additionally, the passage may be adapted to permit passage of the spoolable medium.

In a preferred embodiment the winch drum support shaft is, in use, mounted vertically. Alternatively, the winch drum support shaft may be mounted in any suitable inclination.

The cavity may further comprise a fourth cavity containing electrical communication means. The fourth cavity may be fluidly isolated from the winch chamber such that the fourth cavity is not exposed to wellbore fluids.

The electrical communication means may comprise a rotatable electrical connector, such as a slip ring electrical connector, adapted to electrically connect the spoolable medium on the winch drum with a non-rotating electrical conductor. The electrical conductor may extend externally of the housing.

The fourth cavity may be in fluid communication with any one or combination of the first, second or third cavities. Alternatively, the fourth cavity may be fluidly isolated from the first, second and third cavities. In this arrangement the fourth cavity may comprise a pressure compensator adapted to provide fluid pressure equalization of the fourth cavity with the fluid pressure with any one of the winch chamber, first, second or third cavities.

The cavity is defined above as optionally having first, second, third and fourth cavities. However, it should be understood that the present invention is not limited to having each of these and may have any one or any combination.

The spoolable medium may be adapted to extend from the winch chamber and into a wellbore. The spoolable medium may be adapted to extend through the orifice of the winch chamber. In a preferred embodiment the spoolable medium may be adapted to exit the winch chamber and subsequently extend through the housing, for example through the winch drum support shaft, and into a wellbore. The spoolable medium may be adapted to extend substantially coaxially with the winch drum.

The winch assembly may further comprise a conduit extending from the housing and adapted to accommodate the spoolable medium. The conduit may extend between the housing and a wellbore, either directly or indirectly, and preferably provides fluid communication between the wellbore and the winch chamber. In a preferred embodiment the conduit defines a return path to and from the housing. In this arrangement the conduit extends outwardly away from the housing, and inwardly towards the housing. This arrangement advantageously permits the spoolable medium to extend from the winch chamber, externally of the housing and then through the housing, for example through the winch drum support shaft, and into a wellbore.

The winch assembly may further comprise a sheave arrangement or assembly adapted to support the spoolable medium while permitting a direction change of the spoolable medium to be achieved. The sheave arrangement may be provided within the conduit. In this embodiment the conduit may comprise a first conduit extending between the housing and the sheave and a second conduit extending between the sheave and a wellbore, optionally via the housing.

The sheave may comprise a housing defining a chamber and a roller mounted on a roller shaft rotatably supported within the chamber, wherein the spoolable medium engages the roller. In this arrangement the chamber is adapted to be in fluid communication with a wellbore. In use, displacement of the spoolable medium will effect rotation of the roller. In one embodiment the sheave may comprise a single roller. In an alternative embodiment the sheave may comprise a plurality of rollers each having a roller shaft, wherein the roller shafts are mutually parallel.

The sheave assembly may comprise a load sensor adapted to sense or determine the load applied on the roller by the spoolable medium. This arrangement may therefore enable the tension on the spoolable medium to be determined. The load sensor may be adapted to measure deflection of the roller shaft under loading from the spoolable medium. The load sensor may comprise a strain gauge mounted on the roller shaft.

It will be understood by those of skill in the art that the load on the roller shaft will be proportional to the tension within the spoolable medium. For example, in embodiments where a single roller is provided the load on the roller shaft may be twice the tension in the spoolable medium, and where two rollers are provided the load on each roller shaft may be a lower multiple of the tension in the spoolable medium.

The sheave assembly may comprise a rotational sensor adapted to sense or determine the rotational speed of the roller. The rotational sensor may comprise a target mounted on one of the roller and the sheave housing, and a pick-up sensor mounted on the other of the roller and the housing, such that relative movement of the target and pick-up sensor may be used to determine the rotational speed of the roller. The rotational sensor may be utilised to determine the speed of the spoolable medium being extended into or retrieved from a wellbore. Additionally, the rotational sensor may be utilised to determine the length of spoolable medium extending into a wellbore.

The sheave assembly may comprise a bearing cavity disposed within the housing and containing bearings for rotatably supporting the roller shaft. The bearing cavity is preferably fluidly isolated from the roller chamber, preferably via a seal arrangement, such as a dynamic shaft seal. The sheave assembly may comprise a pressure compensator adapted to maintain the fluid pressure within the bearing cavity substantially equal to the fluid pressure within the roller chamber. Accordingly, the pressure differential across the dynamic shaft seal may therefore be minimised. The pressure compensator may be adapted to apply a positive pressure into one of the roller chamber and bearing cavity, and preferably into the bearing cavity.

The winch assembly may comprise a spooling mechanism adapted to ensure the spoolable medium is properly spooled from and onto the winch drum. The spooling mechanism may comprise a spooling carriage located adjacent the winch drum, wherein the spooling carriage is adapted to be engaged by the spoolable medium and be displaceable in an axial direction relative to the winch drum. The spooling carriage may comprise a roller adapted to be engaged by the spoolable medium. The spoolable medium may be engaged with the roller such that the roller re-orientates the spoolable medium. In a preferred embodiment the roller is adapted to re-orientate the spoolable medium from a direction which is substantially tangential to the winch drum to a direction which is substantially parallel to the winch drum.

The spooling carriage may be displaced at a velocity proportional to the rotational velocity of the winch drum. This arrangement may therefore permit the spoolable medium to be wrapped around or from the winch drum at the desired rate.

The spooling mechanism may comprise a pair of support members upon which the spooling carriage is mounted, wherein the carriage is axially translated along said support members. Providing twin support members provides a robust support for the carriage.

At least one of the support members may be adapted to axially displace the spooling carriage. At least one of the support members may comprise a thread formed on the outer surface thereof, wherein the spooling carriage engages said thread and is displaced along said support member by rotation of said member. In a preferred embodiment at least one of the support members comprises a pair of threads arranged in reverse directions and adapted to permit the spooling carriage to be displaced in reverse directions. Both of the support members may comprise a thread adapted to displace the carriage.

At least one and preferably both of the support members may be disposed within the winch chamber and extend through the divider, plate and into the first cavity. In this arrangement the support members may be adapted to be rotated by the drive assembly mounted within the first cavity.

The spooling assembly may comprise at least one guide member upon which the spooling carriage is slidably mounted. The at least one guide member may advantageously assist to accommodate bending loads experienced by the carriage caused by the forces applied by the spoolable medium. In a preferred embodiment a pair of guide members are provided.

The spooling carriage may comprise a follower body adapted to be mounted on at least one of the support members, wherein the follower body is adapted to engage at least one thread formed in the support member. Accordingly, the spooling carriage may be displaced by interaction of the thread and follower body.

The spooling carriage preferably comprises a support body adapted to engage at least one guide bar. The follower body may be mounted on the support body. In one embodiment the follower body may be rigidly mounted on the support body, and may be integrally formed with the support body. In an alternative and preferred embodiment the follower body is coupled to the support body via a non-rigid connection, such that relative movement between the support body and follower body is permitted. This relative movement may therefore enable the follower body to be isolated from bending forces which are experienced by the support body.

The non-rigid connection may comprise a pin connection, wherein a pin extends between the support body and follower body. The pin may be received within a hole formed in one of the support body and follower body, wherein the pin includes an enlarged diameter portion adapted to engage the inner surface of said hole. Accordingly, pivoting motion may be achieved about the enlarged diameter section of the pin, thus permitting the relative movement of the support body and the follower body.

The winch assembly may further comprise a sensor assembly adapted to sense or determine the quantity of spoolable medium wound onto the winch drum at any time. It is understood that a spoolable medium is wound onto a winch drum to define a number of layers, wherein each layer includes a number of wraps of the spoolable medium.

The sensor assembly may comprise a layer sensor adapted to determine the number of layers of spoolable medium on the winch drum. The layer sensor may comprise a displaceable element adapted to engage the outermost layer on the winch drum, wherein displacement of the displaceable element may be used to determine the number of layers present on the winch drum. That is, knowing the thickness of each layer and the displacement of the displaceable element from a reference point will permit the number of layers to be determined. The reference point is preferably the outer surface of the winch drum upon which the spoolable medium is wound.

The layer sensor may comprise biasing means adapted to bias and maintain the displaceable element into contact with the spoolable medium on the winch drum. Accordingly an increasing number of layers will cause the displaceable element to be displaced outwardly relative to the winch drum against the bias of the biasing means, and a decreasing number of layers will cause the displaceable element to be displaced or biased inwardly relative to the winch drum. The biasing means may comprise a spring, such as a coiled spring, torsion spring or the like.

The displaceable element may be provided in the form of an elongate element adapted to extend across at least two wraps of spoolable medium within a layer, and preferably across all wraps within a layer. In this preferred embodiment the elongate element is adapted to extend substantially across the entire length on the winch drum.

The displaceable element may be mounted on a support member, preferably pivotally mounted. The support member and the displaceable element may be aligned substantially parallel to each other, and the displaceable element may be pivotally mounted on the support member via support arms.

The layer sensor may comprise a position sensor adapted to sense or determine the position of the displaceable member. The position sensor may comprise an inductance sensor or the like.

The sensor assembly may comprise a wrap sensor adapted to determine the number of wraps of spoolable medium contained within a layer supported on a winch drum, and preferably the number of wraps present in the outermost layer on a winch drum. The wrap sensor preferably comprises a position sensor arrangement adapted to sense or determine the position of a final wrap within a layer relative to the axial extent of the winch drum. It will be understood that the final wrap within a layer is that wrap which ultimately extends from the winch drum in a tangential direction.

In a preferred embodiment the position sensor arrangement is comprised within a spooling arrangement associated with the winch drum, wherein the position sensor arrangement comprises a position sensor adapted to sense or determine the position of a spooling carriage. Accordingly, by determining the position of a spooling carriage, the position of the final wrap within a layer may be determined. Knowing the diameter or width of the spoolable medium may therefore permit the number of wraps to be determined based on the position of the final wrap along the axial extent of the winch drum.

The winch drum may be adapted to support a spoolable medium comprising wireline, coiled tubing or the like.

The winch assembly may be adapted for use in deploying and retrieving tools into and from a wellbore.

The winch assembly may be provided in combination with a tool storage assembly, wherein the tool storage assembly includes a number of tools which may be individually selected and secured to the spoolable medium to be run into a wellbore.

The winch assembly may form part of a tool deployment system adapted to store and deploy tools into a wellbore to perform in-well operations such as intervention operations.

According to a second aspect of the present invention there is provided a tool deployment system comprising:

a tool storage assembly comprising a housing adapted to be mounted relative to a wellhead, wherein the tool storage assembly comprises at least one tool within the housing;

a winch assembly according to the first aspect mounted relative to the wellhead;

a spoolable medium spoolably supported by the winch drum of the winch assembly and adapted to engage and support at least one tool from the tool storage assembly to be deployed into a wellbore.

According to a third aspect of the present invention, there is provided a layer sensor adapted to determine the number of layers of a spoolable medium wound onto a winch drum, said layer sensor comprising:

a displaceable member adapted to engage the outermost layer of a spoolable medium wound onto a winch drum; and

a displacement sensor adapted to determine the position of the displaceable member relative to the outer surface of the winch drum.

Accordingly, in use, knowing the thickness of each layer and the displacement of the displaceable element from the outer surface of the winch drum will permit the number of layers to be determined.

The layer sensor may comprise biasing means adapted to bias and maintain the displaceable element into contact with the outermost layer of spoolable medium on the winch drum. Accordingly an increasing number of layers will cause the displaceable element to be displaced outwardly relative to the winch drum against the bias of the biasing means, and a decreasing number of layers will cause the displaceable element to be displaced or biased inwardly relative to the winch drum. The biasing means may comprise a spring, such as a coiled spring, torsion spring or the like.

The displaceable element may comprise an elongate member adapted to extend across at least two wraps of spoolable medium within a layer, and preferably across all wraps within a layer. In this preferred embodiment the elongate member is adapted to extend substantially across the entire length on the winch drum.

The displaceable element may be mounted on a support member. The displaceable element may be pivotally mounted on a support member, such that the support member may pivot or orbit relative to the support member as the number of layers on the winch drum increases or decreases. The displaceable element may be pivotally mounted on the support member via at least one support arm. The support member and the displaceable element may be aligned substantially parallel to each other.

The position sensor may comprise a hall effect sensor, inductance sensor or the like.

According to a fourth aspect of the present invention there is provide a winch assembly comprising:

a winch drum;

a spoolable medium spoolably mounted on the winch drum; and

a layer sensor according to the third aspect.

The winch assembly may comprise a housing, within which housing the winch drum is mounted. Accordingly, the housing prevents the quantity of spoolable medium present on the winch drum to be visually determined. The housing may be adapted to be exposed to elevated pressures. By elevated pressures it is meant that the pressure within the housing exceeds the pressure external of the housing. The housing may be adapted to be in fluid communication with a wellbore.

The winch assembly may comprise a spooling mechanism adapted to ensure the spoolable medium is properly spooled from and onto the winch drum. The spooling mechanism may comprise a spooling carriage located adjacent the winch drum, wherein the spooling carriage is adapted to be engaged by the spoolable medium and be displaceable in an axial direction relative to the winch drum.

The winch assembly may further comprise a wrap sensor adapted to determine the number of wraps of spoolable medium contained within a layer supported on a winch drum, and preferably the number of wraps present in the outermost layer on a winch drum. The wrap sensor preferably comprises a position sensor arrangement adapted to sense or determine the position of a final wrap within a layer relative to the axial extent of the winch drum. It will be understood that the final wrap within a layer is that wrap which ultimately extends from the winch drum in a tangential direction.

In a preferred embodiment the position sensor arrangement is comprised within the spooling mechanism, wherein the position sensor arrangement comprises a position sensor adapted to sense or determine the position of a spooling carriage. Accordingly, by determining the position of a spooling carriage, the position of the final wrap within a layer may be determined. Knowing the diameter or width of the spoolable medium may therefore permit the number of wraps to be determined based on the position of the final wrap along the axial extent of the winch drum.

According to a fifth aspect of the present invention there is provided a drive assembly for use in providing drive to a mechanism contained within a housing, said drive assembly comprising:

a drive source adapted to be mounted on an outer wall surface of a housing;

a drive shaft casing mounted on an inner wall surface of the housing;

a drive shaft extending from the drive source and through the wall of the housing and into the drive shaft casing; and

a non contact coupling adapted to drivingly couple the drive shaft and the mechanism.

A static seal may be provided between the shaft casing and the internal surface of the housing. The static seal may be adapted to prevent or minimise leakage of fluid from the housing. Accordingly, the shaft casing may be sealed from the fluid within the housing. This arrangement is particularly advantageous in that sealing integrity to prevent leakage of fluid from the housing is not dependent on a dynamic seal associated with the shaft. Additionally, in this arrangement a relatively large pressure differential may be established between the housing and the shaft casing and optionally the drive source or external environment in that sealing integrity may be maintained by a more efficient static seal rather than a dynamic seal.

The shaft casing may be in fluid communication with the drive source through the wall of the housing. In one embodiment a pressure compensator may be provided between the drive source and the ambient environment. In this arrangement the fluid pressure within the drive source and the shaft casing may be maintained substantially balanced with the ambient pressure.

The drive source may comprise a motor, such as an electric motor, hydraulic motor or the like.

The non-contact coupling preferably comprises a magnetic coupling arrangement.

The mechanism may comprise a winch drum, and may be directly coupled to the drive shaft via the non-contact coupling, or alternatively may be coupled also via a transmission assembly, such as a gear box or the like.

The drive assembly may further comprise secondary drive means. The secondary drive means may comprise a shaft interface adapted to permit an external drive source to be drivingly coupled to the drive shaft of the drive assembly. The shaft interface may be located externally of the housing. The shaft interface may be adapted to be engaged by a Remotely Operated Vehicle (ROV) or the like.

In one embodiment the shaft casing extends across the housing between internal wall surfaces thereof, wherein the shaft casing is sealingly secured to the internal wall surfaces of the housing. The drive shaft may extend through the shaft casing between the drive source and the secondary drive means.

According to a sixth aspect of the present invention there is provided a winch assembly comprising:

a housing defining a winch chamber;

a winch drum rotatably mounted within the winch chamber;

a drive source mounted on an outer wall surface of the housing;

a drive shaft casing mounted on an inner wall surface of the housing;

a drive shaft extending from the drive source and through the wall of the housing and into the drive shaft casing; and

a non-contact coupling adapted to drivingly couple the drive shaft and the winch drum.

According to a seventh aspect of the present invention, there is provided a spooling assembly for use with a winch drum, said spooling assembly comprising:

a drive screw mounted to be parallel with a central axis of a winch drum;

a guide member mounted to be parallel with the drive screw;

a spooling carriage adapted to engage a spoolable medium extending from the winch drum and comprising a follower body threadably coupled to the drive screw and a support body slidably mounted on the guide member, wherein rotation of the drive screw effects axial translation of the spooling carriage.

Accordingly, in use, the drive screw may be rotated such that the threaded engagement of the drive screw with the follower body effects translation of the spooling carriage axially along the length of the drive screw and guide member. The rate of the axial translation may be proportional to the rotational speed of the winch drum such that the spoolable medium may be properly spooled from and onto the winch drum. The drive screw and winch drum may be drivingly coupled, for example via a gear train, chain drive, belt drive or the like.

The follower body may comprise an axial through bore adapted to accommodate the drive screw. The support body may comprise an axial through bore adapted to accommodate the guide member.

The spooling carriage may further comprise a spoolable member engagement element, which element preferably comprises a roller. The engagement element may be adapted to re-orientate the spoolable medium, preferably from a direction which is substantially tangential to the winch drum to a direction which is substantially parallel to the winch drum.

In a preferred embodiment the engagement element is mounted on the support body, such that forces applied on the engagement element may be transmitted to the support body.

The drive screw may be adapted to support axial loading experienced by the spooling carriage, wherein said axial loading is transmitted from the spooling carriage to the drive screw via the threaded connection between the follower body and the drive screw. Additionally, the guide member may be adapted to support or accommodate bending loads established by engagement of the spooling carriage and the spoolable medium.

The follower body may be rigidly mounted on the support body, and may be integrally formed with the support body. In this arrangement all forces applied to the support body from the engagement element will be transmitted to the follower body and ultimately to the drive screw. In some embodiments, however, it is desirable to minimise exposure of the drive screw to certain loads, particularly bending loads, which may affect the operation of the drive screw to translate the spooling carriage.

In a preferred embodiment the follower body is coupled to the support body via a non-rigid connection. The non-rigid connection is preferably adapted to permit a degree of relative movement between the support body and follower. This relative movement may therefore enable the follower body to be isolated from bending forces which are experienced by the support body. That is, displacement of the support body as a result of bending loads will be accommodated by the non-rigid coupling.

The non-rigid connection may comprise a pivot connection. The non-rigid connection may comprise a ball and socket connection, or a connection which functions in the same manner as a ball and socket connection.

In a preferred embodiment, the non-rigid connection may comprise a pin connection, wherein a pin extends between the support body and follower body. The pin may be received within a hole formed in one of the support body and follower body, wherein the pin includes an enlarged diameter portion adapted to engage the inner surface of said hole. Accordingly, pivoting motion may be achieved about the enlarged diameter section of the pin, thus permitting the relative movement of the support body and the follower body.

In a preferred embodiment the pin may be rigidly secured to the support body and extend into a hole formed in the follower body. The pin preferably comprises an enlarged diameter portion in the form of a circumferential protrusion extending outwardly from the surface of the pin, wherein the enlarged diameter portion substantially corresponds to the diameter of the hole formed within the follower body. The enlarged diameter portion advantageously functions as a fulcrum, permitting the pin to be pivoted relative to the follower body, thus providing a non-rigid coupling which permits relative movement between the support body and the follower body.

Preferably, the pin extends from the support body at an angle substantially perpendicular to the central axis of the guide member. Preferably also, the pinhole defined in the follower body extends at an angle substantially perpendicular to the central axis of the drive screw. Accordingly, axial loading may be readily transmitted between the support body and the follower body, while bending loads acting to deflect the guide member from a position which is parallel to the drive screw will be absorbed by the non-rigid connection.

Additionally, the non-rigid connection may assist to permit proper alignment of the support body and the follower body relative to the guide member and drive screw respectively.

### BRIEF DESCRIPTION OF THE DRAWINGS

These and other aspects of the invention will now be described, by way of example only, with reference to the accompanying drawings, in which:

FIG. 1 is a diagrammatic representation of a tool deployment system incorporating a winch assembly in accordance with an embodiment of aspects of the present invention;

FIG. 2 is a diagrammatic cross-sectional view of the winch assembly shown in FIG. 1;

FIG. 3 is a further diagrammatic cross-sectional view of the winch assembly shown in FIG. 1;

FIG. 4 is a perspective view of the winch assembly shown in FIG. 1 with a winch housing removed to show internal details;

FIG. 5 is a perspective view of a spooling carriage of the winch assembly;

FIG. 6 is a partial sectional view of the spooling carriage shown in FIG. 5;

FIG. 7 is a perspective view of a winch drum of the winch assembly incorporating a layer sensor in accordance with an embodiment of aspects of the present invention;

FIG. 8 is a perspective view of a spooling mechanism of the winch assembly showing a wrap sensor arrangement;

FIG. 9 is a front elevation view of a top sheave arrangement of the winch assembly shown in FIG. 1;

FIG. 10 is a cross sectional view of the top sheave arrangement shown in FIG. 9, taken through line 10-10;

FIG. 11 is an enlarged cross-sectional view of the top sheave arrangement shown in FIGS. 9 and 10; and

FIG. 12 is a diagrammatic cross-sectional view of a winch assembly in accordance with an alternative embodiment of the present invention.

### DETAILED DESCRIPTION OF THE DRAWINGS

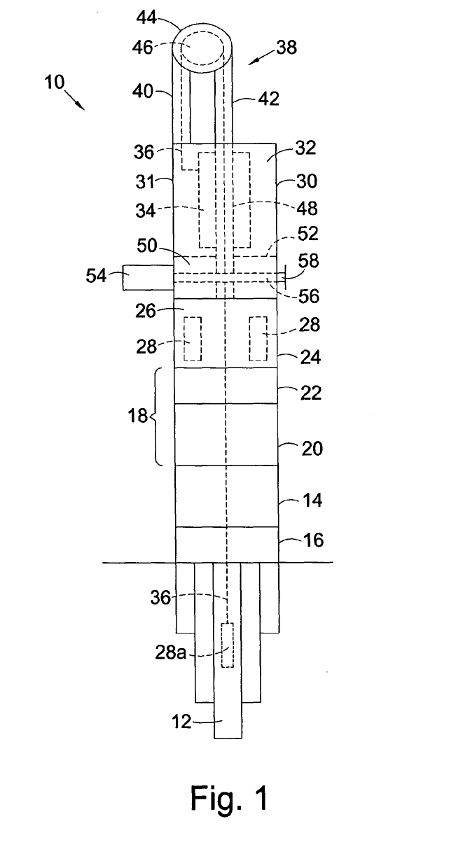

Reference is initially made to FIG. 1 of the drawings in which there is diagrammatically shown a tool deployment system, generally identified by reference numeral 10, in accordance with an embodiment of an aspect of the present invention. As will be discussed in further detail below, the tool deployment system 10 is for use in deploying appropriate tools into a wellbore 12 to perform required in-well operations, such as well intervention operations.

The tool deployment system 10 includes a number of separate assemblies or modules which collectively are mounted on top of a subsea Christmas tree 14, which in turn is mounted on a wellhead 16, as known in the art. The tool deployment system 10 comprises a well control package 18 formed of a valve assembly 20 and a plug pulling tool 22. The valve assembly 20 includes a number of valves for controlling the flow of fluids to and from the wellbore 12, and the plug-pulling tool is for use in retrieving and setting in place plugs from the Christmas tree 14 which are used as a fluid barrier.

Mounted on top of the plug-pulling tool 22 is the tool storage package 24 which includes a tool storage chamber 26 containing a number of tools or tool strings 28. As will be discussed in further detail below, a particular tool string may be selected from the tool chamber 26 and subsequently run into the wellbore 12.

A winch assembly 30 according to aspects of the present invention is mounted above the tool storage package 24 and includes a winch drum 34 mounted within a chamber 32 defined by a winch housing 31 wherein the winch drum 34 supports wireline 36. A top sheave assembly 38 extends above the winch assembly 30 and comprises first and second tubes 40,42 and a sheave 44 which includes a roller 46. The top sheave assembly permits the wireline 36 to be spooled from the winch drum 34 and exit the winch chamber 32 through the first tube 40, over roller 46 of the sheave 44, and subsequently through the second tube 42. The wireline 36 may then extend downwardly through a support shaft 48 of the winch drum 34 and subsequently through the remaining modules of the tool deployment system 10 and ultimately into the wellbore 12.

In use, a particular tool 28a may be selected from the tool chamber 26 and displaced to be presented with a central bore of the tool deployment system 10, and subsequently coupled to the end of the wireline 36. The tool 28a may then be deployed through the tool deployment system 10 and into the wellbore 12 to perform the necessary in-well operations, such as an intervention operation or the like. Once the required in-well operation has been performed the selected tool 28a may be retrieved by the wireline 36 back into the tool storage chamber 26, disconnected from the wireline 36, and subsequently returned to a storage position.

It is to be noted that the winch chamber 32 is in fluid communication with the wellbore 12 via the lower modules of the tool deployment system 10, the winch drum support shaft 48 and the top sheave assembly 38. Accordingly, the winch drum 34 is exposed to wellbore fluids and pressures.

In the embodiment shown in FIG. 1, the winch assembly 30 comprises a first cavity 50 which is separated from the winch chamber 32 via a divider plate 52, wherein the first cavity includes a transmission assembly drivingly coupled to the winch drum 34. A drive motor 54 is mounted on the outer surface of the winch housing 31 and a drive shaft 56 extends from the drive motor 54, through the wall of the housing 31 and into the first cavity 50 to engage the transmission assembly and thus provide a driving force to the winch drum 34. As will be discussed in further detail below, the drive shaft 56 is engaged with the transmission assembly via a non contact magnetic coupling.

The drive shaft 56 extends through the first cavity 50 and exits through an opposing wall surface of the housing 31 and is coupled to a Remotely Operated Vehicle (ROV) interface 58. Accordingly, the drive shaft 56 may be rotated to operate the winch drum by an ROV torque drive which may be required if failure of the drive motor 54 should occur.

The divider plate 52 functions to isolate the winch chamber 32 from the first cavity 50 in order to prevent the first cavity 50 from being exposed to well bore fluids. The first cavity 50 includes a lubricating fluid, such as mineral oil, for lubricating the transmission assembly.

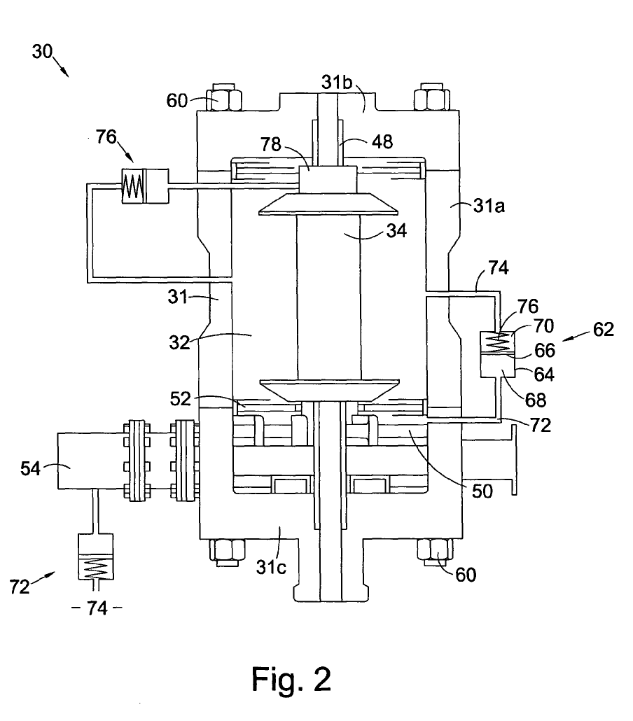

As will be discussed in further detail below, the winch assembly 30 includes a number of pressure compensators, one of which provides pressure compensation between the winch chamber 32 and the first cavity 50. That is, the pressure compensator functions to maintain the lubricating fluid within the first chamber 50 at substantially the same pressure as the wellbore fluid within the winch chamber 32. This arrangement therefore advantageously minimises the pressure differential across the divider plate 52 which in turn minimises the risk of leakage of fluid between the winch chamber 32 and first cavity 50. The arrangement of the various pressure compensators within the winch assembly will now be discussed below with reference to FIG. 2 which is a cross-sectional view of the winch assembly 30.

As shown in FIG. 2, the housing 31 of the winch assembly 30 is composed of a cylindrical centre portion 31a and upper and lower caps or cover portions 31b,31c which are secured to the central portion 31a via plugs and threaded locking rings 60. A sealing arrangement, such as gasket seals may be provided between the centre portion 31a and cover portions 31b,31c.

A first pressure compensator 62 is disposed between the winch chamber 32 and the first cavity 50. The first pressure compensator comprises a cylinder 64 within which is mounted a floating piston 66 which divides the cylinder 64 into first and second chambers 68,70. The first chamber 68 is in fluid communication with the first cavity 50 via a fluid conduit 72, and the second chamber 70 is in fluid communication with the winch chamber 32 via a further fluid conduit 74. In use, fluid pressure within the winch chamber 32 acts against the floating piston 62 which therefore exerts the same pressure present in the winch chamber 32 against the lubricating fluid within the first cavity 50.

The first pressure compensator 62 also includes a forcing mechanism which applies a force against the floating piston 66 to ensure that the pressure within the first cavity 50 is made slightly greater than that within the winch chamber 32. In the embodiment shown the forcing mechanism incorporates a compression spring 76 positioned within the second chamber 70. It should be noted that in embodiments of the invention the wellbore pressure within the winch chamber 32 may be in the region of 690 bar (10,000 psi), and the forcing means may be adapted to apply an additional pressure of 0.69 bar (10 psi) into the first cavity 50. Accordingly, by ensuring that the first cavity 50 is maintained at a slightly greater pressure than the winch chamber 32, leakage across the divider plate 52 will therefore only be able to occur from the cavity 50 and into the chamber 32. This therefore prevents or substantially minimises the possibility of wellbore fluids contaminating the lubricant within the first chamber 50.

A second pressure compensator 72 is disposed between the drive motor 54 and the surrounding ambient seawater 74 such that the pressure within the drive motor 54 may be maintained at substantially the same pressure as the ambient seawater. It is well known that seawater pressure is proportional to water depth, with every 10 m of depth giving a pressure increase of approximately 1 bar. In normal use, the wellbore pressure will, in most cases, exceed the ambient seawater pressure. It should be noted that the second pressure compensator is structured and operates in the same manner as the first pressure compensator 62 and as such no further description shall be provided. However, it is to be noted that the second pressure compensator 72 includes a forcing mechanism which maintains the pressure within the drive motor 54 slightly greater than the ambient seawater pressure. This positive pressure differential within the drive motor 54 therefore ensures that if any leakage occurs this will be from within the drive motor 54 into the ambient seawater 74. Accordingly, this arrangement therefore prevents the drive motor 54 from being contaminated with seawater 74.

A third pressure compensator 76 is disposed between the winch chamber 32 and a slip ring unit 78 mounted on an upper end of the winch drum 34. The slip ring unit 78 provides electrical communication from the wireline conductor 36 (FIG. 1) between the rotating winch drum 34 and the winch drum support shaft 48. Although not shown on FIG. 2, the slip ring unit 78 comprises a sealed housing with a rotating outer section and the fixed inner section. The wireline conductor 36 is connected electrically to the outer section while the inner section has an electrical connection to appropriate control systems, which may be located with the tool deployment system 10 or alternatively at a surface location. The slip ring housing is filled with a die-electric fluid and is therefore sealed from the winch chamber 32 to prevent or substantially minimise leakage of the wellbore fluid into the slip ring housing.

The third pressure compensator 76 is structurally and functionally similar to the first pressure compensator 62 and as such no additional description will be provided. However, it should be noted that the forcing mechanism of the third pressure compensator 74 acts to provide a positive pressure differential within the slip ring unit 78 such that the pressure of the die-electric fluid within the slip ring unit 78 is maintained at a slightly greater pressure than the wellbore fluid within the winch chamber 32. In a similar manner as discussed above, this arrangement ensures that any leakage will occur from the slip ring unit 78 and into the winch chamber 32, therefore substantially minimising or preventing the risk of wellbore fluids leaking into the slip ring unit 78 to contaminate the die-electric fluid and possibly cause damage to the various electrical components of the unit 78.

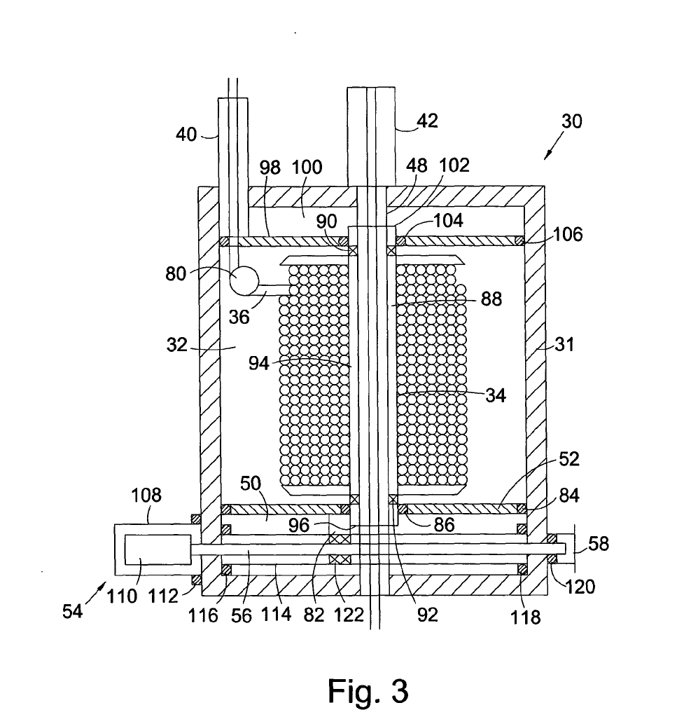

A more detailed description of the structure and function of the winch assembly 30 will now be provided with reference to FIG. 3 in which there is shown a simplified cross-sectional view of the assembly 30 first shown in FIG. 1.

As described above with reference to FIG. 1, the wireline 36 extends from the winch drum 34 and exits the housing 31 via the first tube 40, is reorientated by roller 46 (FIG. 1) and extends downwards through the second tube 42 and subsequently through the winch drum support shaft 48. A spooling mechanism 80, which is diagrammatically represented in FIG. 3 is provided and functions to reorientate the wireline 36 from a direction which is tangential to the winch drum 34 to a direction which is parallel with the central axis of the winch drum 34. The spooling mechanism 80 also functions to ensure that the wireline 36 is correctly spooled from and on to the winch drum 34. A detailed description of the spooling mechanism 80 will be provided later below.

As noted above, a divider plate 52 is disposed within the housing 31 to separate the winch chamber 32 from the first cavity 50, the winch chamber 32 being exposed to wellbore fluids and the first cavity 50 containing a lubricant for lubricating a transmission assembly, identified by reference numeral 82 in FIG. 3. A static seal 84, such as an O-ring, is positioned between an outer periphery of the divider plate 52 and an inner wall surface of the housing 31. Additionally, the divider plate 52 includes a central bore through which a portion of the winch drum 34 extends to be engaged by the transmission assembly 82, wherein a dynamic seal 86 is positioned between the divider plate 52 and the winch drum 34. It is known in the art that the sealing integrity of a static seal is better or more efficient than that of the dynamic seal. Accordingly, the present invention offers significant advantages by providing the first pressure compensator 62 (FIG. 2) which functions to substantially equalise the fluid pressure within the winch chamber 32 and the first cavity 50 and therefore minimise the pressure differential across the dynamic seal 86.

The winch drum 34 comprises a hollow central hub 88 which is rotatably mounted on the winch drum support shaft 48 via upper and lower bearings 90,92. A second cavity 94, which is annular in form, is defined between the outer surface of the winch drum support shaft 48 and the inner surface of the central hub 88. In the embodiment shown the second cavity 94 is in fluid communication with the first cavity 50 via a lower annular port 96. By virtue of the fluid communication between the first and second cavities 50,94, the second cavity 94 is also pressure compensated with the winch chamber 32 via the first pressure compensator 62 (FIG. 2). Also, the bearings 90,92 are lubricated by the same lubricant contained within the first chamber 50.

In the embodiment shown the winch assembly 30 further comprises a further divider plate 98 which separates the winch chamber 32 from a third cavity 100, wherein the third cavity 100 is in fluid communication with the second cavity 94 via an upper annular port 102. Accordingly, the third cavity 100 will also be pressure compensated with the winch chamber 32.

The divider plate 98 also comprises a central bore through which a portion of the winch drum 34 extends, wherein a dynamic seal 104 is provided between the winch drum 34 and the divider plate 98. Also, a static seal 106 is provided between the divider plate 98 and the inner surface of the housing 31. Accordingly, the lubricant contained within the first chamber 50, second chamber 94 and third chamber 100 may be completely isolated from the winch chamber 32.

It should be noted that the further divider plate 98 which defines the third cavity 100 may be omitted and a dynamic seal may be provided between the central hub 88 of the winch drum 34 and the winch drum support shaft 48 to therefore fully isolate the second cavity 94 from the winch chamber 32.

Also, the further divider plate 98 may be provided without any sealing arrangement such that fluid communication between the winch chamber 32 and third cavity 100 may be permitted.

As noted above, and also shown in FIG. 3, a drive motor 54 is secured to the outer surface of the housing 31 and a shaft 56 extends into and through the first cavity 50, and is secured at an opposite end to an ROV interface 58. More specifically, the drive motor includes a motor unit 110 mounted within a motor housing 108. The motor housing 108 is secured to the outer surface of the winch housing 31, for example via bolts, and a static seal 112 is disposed between the motor housing 108 and winch housing 31.

A shaft casing 114 extends across the first cavity 50 and is secured to the inner surface of the housing 31 at one end of the cavity 50 and also to the inner surface of the housing 31 at an opposite end of the cavity 50. A first static seal 116 is disposed between the shaft casing 114 and the inner surface of the housing 31 at one end of the shaft casing, and a second static seal 118 is disposed between the shaft casing 114 and the inner surface of the housing 31 at an opposite end of the shaft casing 114. Accordingly, the shaft casing 114 may be fluidly isolated from the lubricant contained within the first cavity 50.

The drive shaft 56 extends from the motor unit 110, through the wall of the housing 31 and into and through the shaft casing 114. It should be noted that no sealing arrangement is provided between the drive shaft 56 and the wall of the housing 31 such that the motor housing 108 and the shaft casing 114 are in fluid communication with each other. In the embodiment shown the motor housing 108 and shaft casing 114 contain a lubricant and cooling fluid.

As noted above, the drive motor 54, and specifically the cooling and lubricating fluid contained within the motor housing 108 are pressure compensated with the water pressure of the ambient seawater 74 which, as noted above, may be less than the wellbore pressure and thus the pressure within the first cavity 50. Additionally, as the shaft casing 114 is in fluid communication with the motor housing 108, the fluid contained within the shaft casing 114 will thus also be pressure compensated with ambient seawater pressure. However, by providing the motor housing 108 and shaft casing 114 in combination with static seals 112, 116 and 118, the pressure differential between the first cavity 50 and the motor housing 108 and shaft casing 114 may be readily accommodated. Furthermore, the arrangement shown in FIG. 3 advantageously eliminates the requirement to contain the pressure differential between the first cavity 50 and the motor housing 108 and shaft casing 114 utilising a dynamic shaft seal.

The ROV interface 58 is secured to the outer surface of the housing 31 and a dynamic seal 120 is provided to prevent leakage from the shaft casing 114 and motor housing 108 into the ambient seawater 74. The integrity of the dynamic seal 120 is ensured in that the fluid within the shaft casing 114 will substantially be equalised with that of the seawater by virtue of compensator 72 (FIG. 2).

In order to ensure that the shaft casing 114 is entirely fluidly isolated from the first cavity 50, a non-contact coupling is provided to drivingly couple the shaft 56 with the transmission assembly 82. In the embodiment shown the non-contact coupling comprises a magnetic coupling 122.

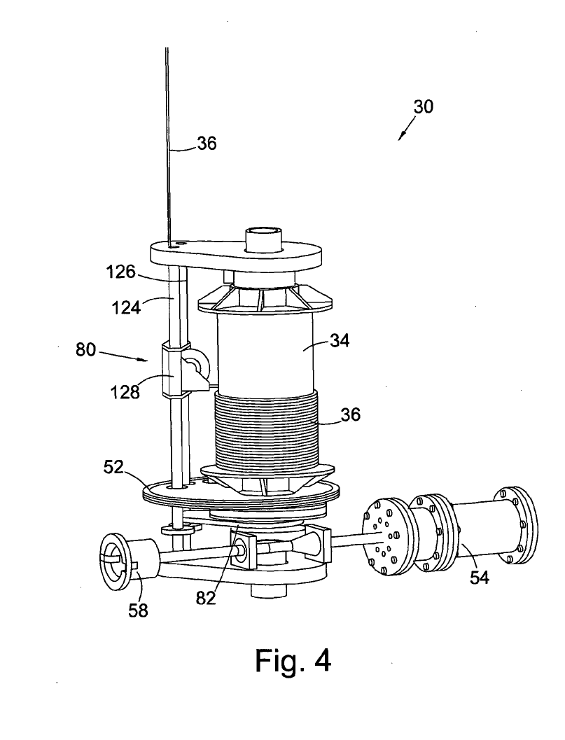

Reference is now made to FIG. 4 of the drawings in which the winch assembly 30 is shown with the outer housing 31 removed so that the winch drum 34 and spooling mechanism 80 (originally introduced with reference to FIG. 3) may be readily viewed.

The spooling mechanism 80 comprises a pair of lead or drive screws 124,126 which extend across the winch chamber 32 and are aligned parallel to each other and to the central rotation axis of the winch drum 34. Each lead screw 124,126 extends through the divider plate 52 and into the first cavity 50, wherein the lead screws 124,126 are drivingly coupled to the transmission assembly 82. Each lead screw 124,126 includes a pair of threads which extend in opposite directions axially along the outer surfaces of the lead screws 124,126, and a spooling carriage 128 is mounted on each lead screw 124,126 and is driven axially therealong in reverse directions by the threads. Although not shown in FIG. 4, the spooling mechanism also comprises a pair of guide rails which extend across the winch chamber 32 and are aligned parallel to each other and to the lead screws 124,126. In use, the spooling carriage 128 is engaged with and slides along each guide member. The guide rails accommodate bending loads which are established by engagement of the wireline 36 with the spooling carriage 128. As noted above, the spooling mechanism 80 functions to ensure that the wireline 36 is correctly spooled from and on to the winch drum 34. To achieve this, the spooling carriage 128 is arranged to be translated axially at a rate proportional to the rotational speed of the winch drum 34.

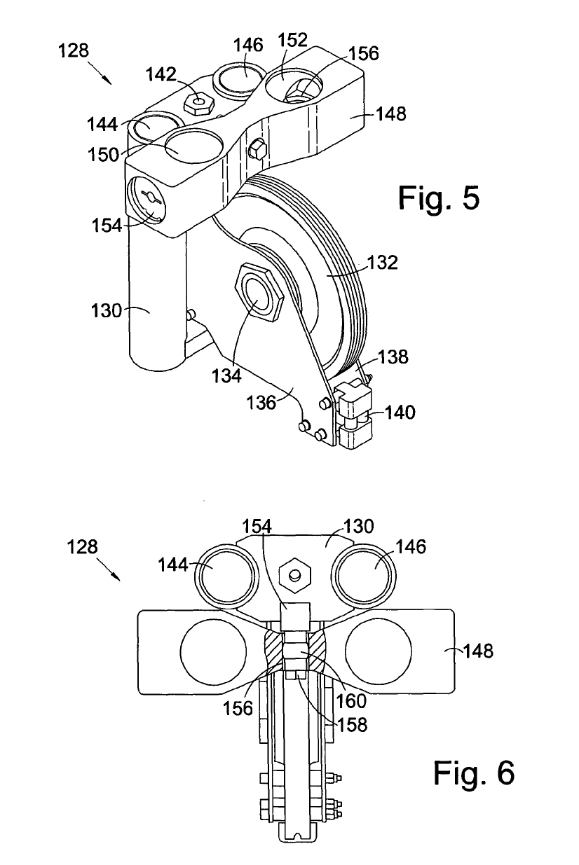

The form and function of the spooling carriage 128 will now be described in further detail with reference to FIGS. 5 and 6. Referring initially to FIG. 5, which is a perspective view of the spooling carriage 128, the spooling carriage 128 comprises a support body 130 which provides support for a wireline roller 132 via an axle 134 mounted between a pair of flange plates 136,138. In use, wireline extends through a guide arrangement 140 and engages the roller 132 to be reorientated by 90° and subsequently extends in a vertical direction through a port 142 provided within the support body 130. Accordingly, the tension within the wireline will exert a combination of axial and bending forces on the spooling carriage 128, and specifically on the support body 130 through the axle 134.

The support body 130 comprises a pair of through bores 144,146 which permit the support body 130 and thus carriage 128 to be slidably mounted on guide rails.

The spooling carriage 128 further comprises a follower body 148 which is secured to the support body 130 via a pinned connection, which will be described in detail below. The follower body 148 comprises a pair of through bores 150,152 which are adapted to permit the follower body 148 to be mounted on respective lead screws 124,126 (FIG. 4). Each through bore 150,152 is provided with a respective thread member 154,156 which permits the follower body 148 to be threadably engaged with the lead screws 124,126.

Referring now additionally to FIG. 6, the connecting arrangement between the support body 130 and the follower body 148 will be described in detail. It should be noted that FIG. 6 is a view of the spooling carriage 128 shown in FIG. 5 from above, with a portion shown in section so that the pinned connection may be readily viewed.

A connecting pin 154 is secured to and extends from the support body 130 in a direction substantially perpendicular to the through bores 144,146, wherein the pin 154 extends through a central hole 156 formed within the follower body 148. The follower body 148 is securely mounted on the pin 154 via a bolt 158. The pin 154 comprises a circumferential projection 160 which has a maximum outer diameter which substantially corresponds to the diameter of the central hole 156 within the follower body 148. In use, the circumferential projection 160 provides a fulcrum about which the follower body may pivot. Accordingly, the connecting pin 154 permits a non-rigid coupling to be achieved between the support body 130 and the follower body 148. In the particular arrangement disclosed, the connecting pin 154 permits axial loading to be transmitted from the support body 130 to the follower body 148, and subsequently to the lead screws 124,126 (FIG. 4). However, the ability of the follower body 148 to pivot relative to the support body 130 will substantially prevent or minimise any non-axial or bending loads from being transmitted from the support body 130 to the follower body 148. Thus, the lead screws 124,126 may be isolated from all loads except those in an axial direction. This arrangement therefore assists to ensure that the loads experienced by the spooling carriage 128 do not adversely affect the operation of the lead screws 124,126 to translate the spooling carriage 128 axially relative to the winch drum 34. Also, the non-rigid connection between the support body 130 and follower body 148 accommodates any misalignment of the lead screws 124,126 and guide rails.

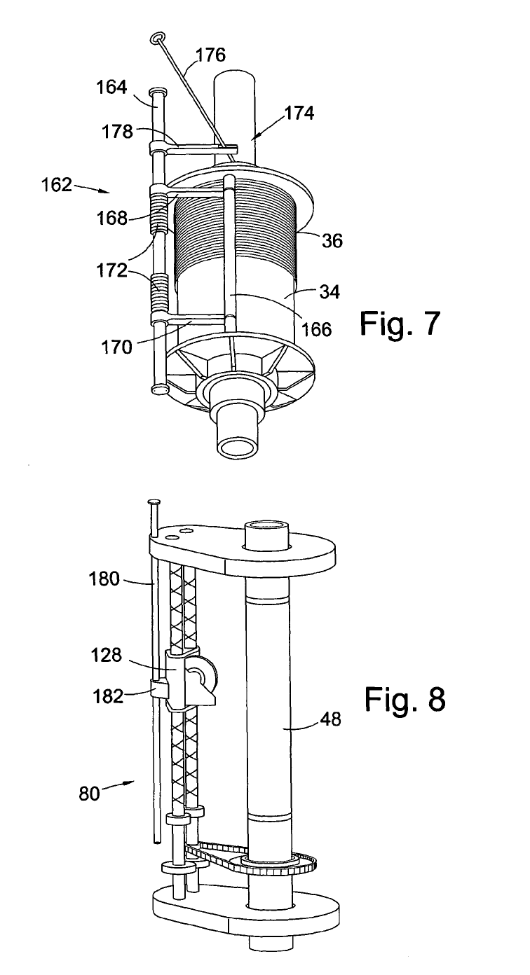

As described above, the winch assembly according to the present invention provides a winch drum which is mounted within a sealed housing and is ultimately intended to be operated at the subsea location, at least in certain embodiments. As such, a winch operator will not be able to visually identify or determine the amount of wireline which is present on the winch drum. The present invention addresses this problem by the provision of a sensing arrangement which seeks to determine the number of layers of wireline which are present on the winch drum, and also to determine the number of wraps that are present in the outermost layer. This sensing arrangement will now be described with reference to FIGS. 7 and 8 of the drawings.

Referring initially to FIG. 7 in which there is shown a perspective view of the winch drum 34 in combination with a layer sensor arrangement 162 adapted to determine the number of layers of wireline 36 on the winch drum 34. The layer sensor arrangement 162 comprises an elongate support member 164 which extends through the winch chamber 32 and is aligned substantially parallel with the central axis of the winch drum 34. A displaceable element 166 is pivotally mounted on the elongate support member 164 via a pair of support arms 168,170, wherein the displaceable element 166 is adapted to engage the outermost layer of wireline 36. A torsion spring arrangement 172 is provided on the elongate member 164 and acts to bias the displaceable element 166 into engagement with the outer layer of wireline 36. Accordingly, an increasing number of layers will cause the displaceable element 166 to be displaced outwardly relative to the winch drum 34 against the bias of the torsional spring arrangement 172, and a decreasing number of layers of wireline 36 will cause the displaceable element 166 to be displaced or biased inwardly relative to the winch drum 34. A position sensor arrangement 174 is provided which consists of a reference member 176 and an arm 178 which is pivoted with the displaceable element 166 so as to move relative to the reference member 176. The position sensor arrangement 174 may comprise an inductance type sensor, hall effect sensor or the like which will permit the position of the arm 178 relative to the reference member 176 to be determined. Thus, knowing the thickness of each layer of wireline 36 and the displacement of the displaceable element 166 relative to the winch drum 34 will permit the number of layers to be determined.

Reference is now made to FIG. 8 of the drawings in which there is shown a perspective view of the spooling mechanism 80 and the winch drum support shaft 48. A wrap sensor arrangement is provided in combination with the spooling mechanism 80 and comprises a reference member 180 which extends axially through the winch chamber 32, and a target member 182 which is secured to the spooling carriage 128 and slides axially along the reference member 180. The reference member 180 and target member 182 may collectively define an inductance sensor, hall effect sensor or the like which permits the position of the target member 182 along the reference member 180 to be determined. Accordingly, by knowing the axial position of the target member 182, the position of the final wrap of wireline 36 of the outermost layer relative to the axial extent of the winch drum 34 may be readily determined.

Thus, knowing the diameter or width of the wireline 36 permits the number of wraps within the outermost layer to be determined based on the position of the final wrap along the axial extent of the winch drum 34.

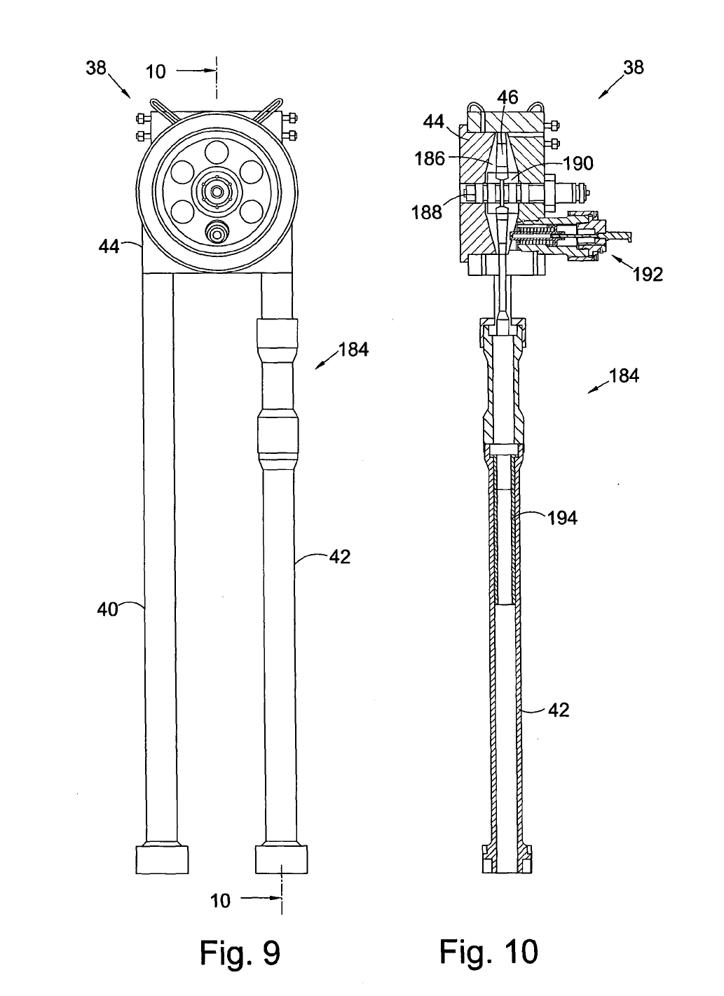

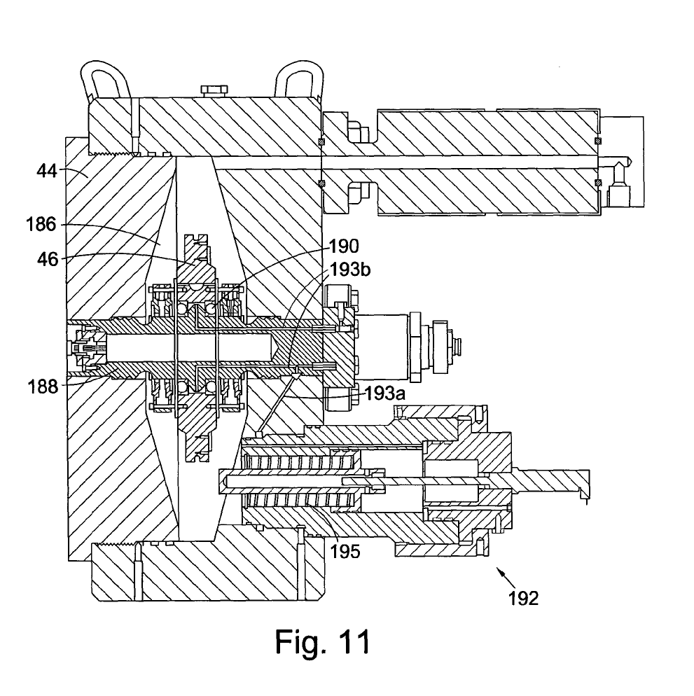

The top sheave assembly 38 shown in FIG. 1 will now be described in further detail with reference to FIGS. 9, 10 and 11. FIG. 9 is a front elevation view of the top sheave assembly 38, FIG. 10 is a cross-sectional view of the top sheave assembly 38 taken through line 10-10 of FIG. 9, and FIG. 11 is an enlarged cross-sectional view of the top sheave assembly 38. As described above, a top sheave assembly 38 comprises a first tube 40 which extends between the winch housing 31 (not shown) and a sheave housing 44, and a second tube 42 which extends between the sheave housing 44 and the winch housing 31. The second tube 42 incorporates a tool catcher, generally identified by reference numeral 184, which is adapted to be engaged by a tool tractor mechanism which is used to engage any one of the tools 28 shown in FIG. 1 to assist in running these tools 28 through the wellbore 12.

Referring now particularly to FIGS. 10 and 11, the sheave housing 44 defines a roller chamber 186 which is in fluid communication with both the tubes 40,42. The sheave roller 46 is disposed within the roller chamber 186 and is mounted on a shaft 188 which is rigidly supported by the housing 44. The sheave roller 46 is mounted on the shaft 188 via a bearing assembly 190 which is filled with lubricating oil. A sealing arrangement is provided between the bearing assembly 190 and the roller chamber to prevent leakage of fluid therebetween. A pressure compensator 192 is disposed between the roller chamber 186 and the bearing assembly 190 and is adapted to maintain the lubricating oil within the bearing assembly 190 at substantially the same pressure as wellbore fluids present in the roller chamber 186. The pressure compensator 192 communicates with the bearing assembly 190 via ports 193a in the housing 44 and ports 193b in the shaft 188. Accordingly, the pressure differential across the sealing arrangement associated with the bearing assembly 190 will be minimised. It should be noted that the pressure compensator 192 also includes a forcing mechanism in the form of a spring 195 (FIG. 11) which is adapted to slightly increase the pressure within the bearing assembly 190 above the pressure within the roller chamber 186. Accordingly, if any leakage does occur then this will be restricted to leakage of lubricating oil from the bearing assembly into the roller chamber 186, which is preferred.

The top sheave assembly 38 further comprises a load sensor arrangement adapted to determine the load applied to the shaft 188, and therefore the tension within the wireline 36 extending over the roller. In a preferred arrangement the load sensor arrangement comprises one or more strain gauges (not illustrated) mounted on the shaft 188 to therefore measure the deflection thereof and thus determine the load being applied. It will be understood by those of skill in the art that the load on the roller shaft 188 may be proportional to the tension within the wireline. For example, where a single roller is provided as in the embodiment shown, the load on the roller shaft 188 will be twice the tension in the wireline 36. In embodiments where a pair of rollers are provided, the load on each roller shaft may be a lower multiple, such as 1.414 times the tension in the wireline 36.

The tool catcher assembly 184 comprises a compression spring and guidance sleeve 194 which collectively define a landing mechanism for a tool tractor (not shown). The landing mechanism provides a soft landing for locating the tractor back into a store position, and also permits tension within the wireline 36 to be maintained, which is preferred.

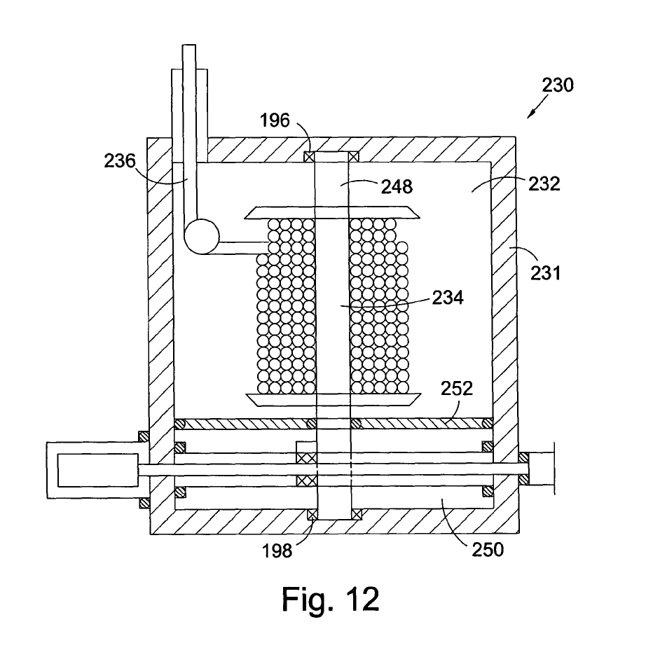

Reference is now made to FIG. 12 of the drawings in which there is shown a diagrammatic cross-sectional view of a winch assembly in accordance with an alternative embodiment of the present invention. The winch assembly 230 is similar to the winch assembly 30 described above, and as such like components share like reference numerals, incremented by 200. Accordingly, the winch assembly 230 includes a housing 231, a winch chamber 232 within which is mounted a winch drum 234, and a first cavity 250 which is separated from the winch chamber 232 via a divider plate 252. In the presently described embodiment, the winch drum 234 is directly mounted on a winch drum support shaft 248, which support shaft 248 is rotatably mounted within the housing 231 via upper and lower bearings 196,198. Accordingly, the winch drum 234 is adapted to be rotated with the support shaft 248. This arrangement differs from that described above in relation to the winch assembly 30 in that the support shaft 48 is stationary and fixed relative to the housing 31.

In the embodiment shown in FIG. 12, the support shaft 248 comprises a solid body such that access for passage of the wireline 236 therethrough is not provided. However, in other embodiments the support shaft 248 may be hollow and therefore may provide an access path for the wireline 236.

It should be noted that the remaining structure of the winch assembly 230 is similar to that described above with reference to the winch assembly 30 and as such no further description shall be given.

It should be understood that the embodiments described above are merely exemplary and that modifications may be made thereto without departing from the scope of the present invention. For example, the winch assembly of the present invention is shown incorporated within a tool deployment system which is located subsea. However, the winch assembly may be located in any desired position, such as at a surface location, for example, on a platform or the like. Additionally, one or more of the various pressure compensators described above may alternatively include a diaphragm structure, or any other structure which permits fluid pressure within one chamber or cavity to be exerted within another chamber or cavity without providing fluid communication therebetween. Also, one or more of the pressure compensators may be provided within the housing of the winch assembly. Furthermore, the divider plate may be moveable or may comprise a moveable portion which acts as a pressure compensator.

Furthermore, it should be noted that while a single sheave roller is provided in the embodiments described above, a pair or rollers may alternatively be utilised. This arrangement may therefore assist to minimise the structural volume of the top sheave assembly, and also minimise the forces applied to each roller.

Additionally, while the embodiments described above are used in conjunction with wireline, any other medium may be accommodated, such as cable, ropes, chains, coiled tubing or the like.

1. A winch assembly comprising:
a housing;
a winch chamber defined within the housing and defining an orifice adapted to permit fluid communication with a wellbore;
a winch drum rotatably mounted within the winch chamber and supporting a spoolable medium;
a cavity defined within the housing and containing a fluid;
a sealing arrangement defined between the winch chamber and the cavity; and
a pressure compensator adapted to maintain the cavity at least at the same pressure as the winch chamber.

2. The winch assembly according to claim 1, wherein the sealing arrangement comprises at least one of a static seal and a dynamic seal.

3. The winch assembly according to claim 1 wherein the pressure compensator comprises a moveable member disposed between the winch chamber and the cavity, wherein one side of the moveable member is in fluid communication with wellbore fluid within the winch chamber and an opposite side of the moveable member is in fluid communication with the fluid within the cavity.

4. The winch assembly according to claim 1, wherein the pressure compensator comprises forcing means adapted to apply a positive pressure into one of the winch assembly and cavity.

5. The winch assembly according to claim 4, wherein the positive pressure is applied into the cavity such that any leakage across the sealing arrangement will be from the cavity and into the winch chamber.

6. The winch assembly according to claim 1, wherein the cavity comprises a transmission assembly.

7. The winch assembly according to claim 1, wherein the cavity comprises a first cavity defined within the housing, and a divider plate mounted within the housing to separate the winch chamber from the first cavity.

8. The winch assembly according to claim 7, further comprising a drive assembly at least partially contained within the first cavity and adapted to be coupled to the winch drum to cause said winch drum to rotate.

9. The winch assembly according to claim 8, wherein the drive assembly comprises a drive source incorporating a drive shaft coupled to the winch drum.

10. The winch assembly according to claim 9, wherein the drive source is mounted externally of the cavity, and the drive shaft extends into the first cavity through a wall portion of the housing to engage the winch drum.

11. The winch assembly according to claim 9, wherein the drive assembly further comprises a shaft casing coupled to an internal surface of the cavity, wherein the drive shaft extends through the wall of the housing and into the shaft casing.

12. The winch assembly according to claim 11, wherein the shaft casing is in fluid communication with the drive source through the wall of the housing.

13. The winch assembly according to claim 9, wherein a pressure compensator is provided between the drive source and the ambient environment.

14. The winch assembly according to claim 11, wherein a static seal is provided between the shaft casing and the internal surface of the cavity.

15. The winch assembly according to claim 9, wherein the shaft is indirectly coupled to the winch drum via a non-contact coupling arrangement.

16. The winch assembly according to claim 11, wherein the shaft casing extends across the first cavity between internal wall surfaces of said cavity, and wherein the shaft casing is sealingly secured to the internal wall surfaces of the first cavity.

17. The winch assembly according to claim 16, wherein the drive shaft extends through the shaft casing between the drive source and secondary drive means.

18. The winch assembly according to claim 1, further comprising a winch drum support shaft adapted to support the winch drum and permit rotation thereof within the winch chamber.

19. The winch assembly according to claim 1, wherein the cavity comprises a first cavity defined within the housing, and a divider plate mounted within the housing to separate the winch chamber from the first cavity, and wherein the cavity comprises a second cavity defined between the winch drum support shaft and a winch drum tubular support member, wherein the second cavity contains winch drum bearings.

20. The winch assembly according to claim 19, wherein the second cavity is in fluid communication with the first cavity.

21. The winch assembly according to claim 1, wherein the cavity comprises:
a first cavity defined within the housing;
a second cavity defined within the housing; and
a third cavity defined within the housing.

22. The winch assembly according to claim 21, wherein a divider plate is provided within the housing to separate the winch chamber from the third cavity.

23. The winch assembly according to claim 21, wherein the third cavity is in fluid communication with the second cavity.

24. The winch assembly according to claim 18, wherein the winch drum support shaft is tubular and defines a through bore adapted to provide a passage extending through the housing.

25. The winch assembly according to claim 21, wherein the cavity further comprises a fourth cavity containing electrical communication means.

26. The winch assembly according to claim 1, further comprising a sheave arrangement or assembly adapted to support the spoolable medium while permitting a direction change of the spoolable medium to be achieved.

27. The winch assembly according to claim 26, wherein the sheave comprises a housing defining a chamber and a roller mounted on a roller shaft rotatably supported within the chamber, wherein the spoolable medium engages the roller.

28. The winch assembly according to claim 27, wherein the chamber is adapted to be in fluid communication with a wellbore.

29. The winch assembly according to claim 27, wherein the sheave assembly comprises a bearing cavity disposed within the housing and containing bearings for rotatably supporting the roller shaft, and wherein the sheave assembly comprises a pressure compensator adapted to maintain the fluid pressure within the bearing cavity substantially equal to the fluid pressure within the roller chamber.

30. The winch assembly according to claim 1, further comprising a spooling mechanism.

31. The winch assembly according to claim 30, wherein the spooling mechanism comprises a spooling carriage located adjacent the winch drum, wherein the spooling carriage is adapted to be engaged by the spoolable medium and be displaceable in an axial direction relative to the winch drum.

32. The winch assembly according to claim 31, wherein the spooling carriage comprises a follower body adapted to be mounted on at least one support member, wherein the follower body is adapted to engage at least one thread formed in the support member.

33. The winch assembly according to claim 32, wherein the follower body is coupled to a carriage support body via a non-rigid connection.

34. The winch assembly according to claim 33, wherein the non-rigid connection may comprise a pin connection, wherein a pin extends between the support body and follower body and is received within a hole formed in one of the support body and follower body, wherein the pin includes an enlarged diameter portion adapted to engage the inner surface of said hole.

35. The winch assembly according to claim 1, further comprising a sensor assembly adapted to sense or determine the quantity of spoolable medium wound onto the winch drum at any time.

36. The winch assembly according to claim 35, wherein the sensor assembly comprises a layer sensor adapted to determine the number of layers of spoolable medium on the winch drum, wherein the layer sensor comprises a displaceable element adapted to engage the outermost layer on the winch drum, wherein displacement of the displaceable element is used to determine the number of layers present on the winch drum.

37. The winch assembly according to claim 35, wherein the sensor assembly comprises a wrap sensor adapted to determine the number of wraps of spoolable medium contained within a layer supported on a winch drum.

38. The winch assembly according to claim 37, wherein the wrap sensor comprises a position sensor arrangement adapted to sense or determine the position of a final wrap within a layer relative to the axial extent of the winch drum, wherein the position sensor arrangement is comprised within a spooling arrangement associated with the winch drum, wherein the position sensor arrangement comprises a position sensor adapted to sense or determine the position of a spooling carriage.

39. A tool deployment system comprising:
a tool storage assembly comprising a housing adapted to be mounted relative to a wellhead, wherein the tool storage assembly comprises at least one tool within the housing;
a winch assembly according to the first aspect mounted relative to the wellhead; and
a spoolable medium spoolably supported by the winch drum of the winch assembly and adapted to engage and support at least one tool from the tool storage assembly to be deployed into a wellbore.

40. A layer sensor adapted to determine the number of layers of a spoolable medium wound onto a winch drum, said layer sensor comprising:
a displaceable member adapted to engage the outermost layer of a spoolable medium wound onto a winch drum; and
a displacement sensor adapted to determine the position of the displaceable member relative to the outer surface of the winch drum.

41. The layer sensor according to claim 40, wherein the displaceable element comprises an elongate member adapted to extend across at least two wraps of spoolable medium within a layer.

42. A winch assembly comprising:
a winch drum;
a spoolable medium spoolably mounted on the winch drum; and
a layer sensor according to the third aspect.

43. The winch assembly according to claim 42, further comprising a housing within which the winch drum is mounted.

44. A drive assembly for use in providing drive to a mechanism contained within a housing, said drive assembly comprising:
a drive source adapted to be mounted on an outer wall surface of a housing;
a drive shaft casing mounted on an inner wall surface of the housing;
a drive shaft extending from the drive source and through the wall of the housing and into the drive shaft casing; and
a non contact coupling adapted to drivingly couple the drive shaft and the mechanism.

45. The drive assembly according to claim 44, wherein a static seal is provided between the shaft casing and the internal surface of the housing.

46. The drive assembly according to claim 44, wherein the shaft casing is in fluid communication with the drive source through the wall of the housing.

47. The drive assembly according to claim 44, wherein a pressure compensator is provided between the drive source and the ambient environment.

48. The drive assembly according to claim 44, wherein the shaft casing extends across the housing between internal wall surfaces thereof, wherein the shaft casing is sealingly secured to the internal wall surfaces of the housing.

49. A winch assembly comprising:
a housing defining a winch chamber;
a winch drum rotatably mounted within the winch chamber;
a drive source mounted on an outer wall surface of the housing;
a drive shaft casing mounted on an inner wall surface of the housing;
a drive shaft extending from the drive source and through the wall of the housing and into the drive shaft casing; and
a non-contact coupling adapted to drivingly couple the drive shaft and the winch drum.

50. A spooling assembly for use with a winch drum, said spooling assembly comprising:
a drive screw mounted to be parallel with a central axis of a winch drum;
a guide member mounted to be parallel with the drive screw; and
a spooling carriage adapted to engage a spoolable medium extending from the winch drum and comprising a follower body threadably coupled to the drive screw and a support body slidably mounted on the guide member, wherein rotation of the drive screw effects axial translation of the spooling carriage.
